(19) United States
(12) Patent Application Publication
(10) Pub. No.: US 2024/0320797 A1
(43) Pub. Date: Sep. 26, 2024

(54) SYSTEM AND METHOD FOR EFFICIENT HARDWARE-ACCELERATED NEURAL NETWORK CONVOLUTION

(71) Applicant: Micron Technology, Inc., Boise, ID (US)

(72) Inventor: Christian Stroemel, Wauwatosa, WI (US)

(21) Appl. No.: 18/590,759

(22) Filed: Feb. 28, 2024

Related U.S. Application Data
(60) Provisional application No. 63/491,482, filed on Mar. 21, 2023.

(51) Int. Cl. G06T 5/60; G06T 5/50

(52) U.S. Cl. CPC G06T 5/60; G06T 5/50; G06T 2207/20021; G06T 2207/20084; G06T 2207/20221

(57) ABSTRACT

A system for providing efficient-hardware accelerated neural network convolution is disclosed. The system receives an input image for an artificial intelligence task for a deep learning accelerator. The system divides the image in to equally-sized partially overlapping image patches and applies a Fast Fourier Transform to the image patches. A size of an image filter is padded to match a size of the image patches and a Fast Fourier Transform to applied to the image filter. For each pixel in each patch, a matrix-vector product is computed between channels of each image patch and a matrix from a corresponding pixel location in the image filter. An inverse Fast Fourier Transform is applied to the matrix-vector product to convert each image to the spatial domain. A convolved version of the image is reconstructed by summing overlapping edges of the patches or by discarding overlapping regions of the patches.

### RELATED APPLICATIONS

The present application claims priority to Prov. U.S. Pat. App. Ser. No. 63/491,482 filed Mar. 21, 2023, the entire disclosures of which application are hereby incorporated herein by reference.

### FIELD OF THE TECHNOLOGY

At least some embodiments disclosed herein relate to neural networks, deep learning technologies, hardware accelerators, convolution optimization technologies, and more particularly, but not limited to, a system and method for efficient hardware-accelerated neural network convolution.

### BACKGROUND

Conducting artificial intelligence tasks often takes significant processing power and utilizing of a variety of artificial intelligence algorithms to support the functionality provided by artificial intelligence model configured to conduct such tasks. With the continually-increasing volumes of data, images, and content to process in today's technological age, being able to process such tasks efficiently has become increasingly important and necessary. Notably, for example, convolution operations account for a majority of the computation time in most modern deep learning models utilized in neural networks and systems. To attempt to reduce computation time, the technology industry has moved to utilizing deep learning accelerators to cope with the large amount of computational burden of deep learning inference. Despite the foregoing, existing deep learning accelerator technologies perform convolutions in a naïve and suboptimal fashion.

Convolutional layers are often the basic building blocks of many popular neural networks, such as image-based neural networks. Such convolutional layers may be utilized to facilitate image classification, object recognition, generative image models, and other image-related tasks. Such layers are called convolutional because the layers often apply the mathematical concept of signal convolution to an input image. In certain implementations, the convolutional layer may utilize a set of filters that are repeatedly tiled across an input image in a sliding window fashion. The foregoing process provides the useful property of translation variance when dealing with image data. Since existing technologies require the image filter to be repeatedly tiled across an input image, the convolution layers utilized to facilitate artificial intelligence tasks are very computationally intensive and often comprise the bulk of the computational cost in most image-based artificial intelligence or machine learning models utilized in neural networks. Based on at least the foregoing, artificial intelligence and neural network technologies may be enhanced to provide superior processing of artificial intelligence tasks, while also utilizing fewer computer resources.

### BRIEF DESCRIPTION OF THE DRAWINGS

The embodiments are illustrated by way of example and not limitation in the figures of the accompanying drawings in which like references indicate similar elements.

FIG. 1 illustrates an exemplary system for providing efficient hardware-accelerated neural network convolution according to embodiments of the present disclosure.

FIG. 2 illustrates an exemplary integrated circuit device including a deep learning accelerator and memory for use with the system of FIG. 1 according to embodiments of the present disclosure.

FIG. 3 illustrates an exemplary deep learning accelerator and memory configured to operate with an artificial neural network for use with the system of FIG. 1 according to embodiments of the present disclosure.

FIG. 4 illustrates an exemplary visual example of a convolution according to embodiments of the present disclosure.

FIG. 5 illustrates an exemplary visual example of a convolution involving application of a Fast Fourier Transform according to embodiments of the present disclosure.

FIG. 6 illustrates an exemplary visual example of convolution incorporating overlap-add according to embodiments of the present disclosure.

FIG. 7 shows an exemplary method for providing efficient hardware-accelerated neural network convolution involving overlap-add in accordance with embodiments of the present disclosure.

FIG. 8 shows an exemplary method for providing efficient hardware-accelerated neural network convolution involving overlap-save in accordance with embodiments of the present disclosure.

FIG. 9 illustrates a schematic diagram of a machine in the form of a computer system within which a set of instructions, when executed, may cause the machine to facilitate efficient hardware-accelerated neural network convolution according to embodiments of the present disclosure.

### DETAILED DESCRIPTION

The following disclosure describes various embodiments for system 100 and accompanying methods for providing efficient hardware-accelerated neural network convolution. In particular, embodiments disclosed herein provide the efficiently conduct neural network convolutions, such as by utilizing algorithms that may utilize the features and functionality provided by deep learning accelerators. While Fast Fourier convolution is a possible approach that allows convolutions to be computed in lower time complexity and fewer mathematical operations, traditional techniques for computing convolutions in the frequency domain are often unsuitable for implementation in hardware, such as a deep learning accelerator. In certain embodiments, the present disclosure incorporates the use of overlap-add, overlap-save, and/or other algorithms for use in deep learning accelerators, which enable efficient computation of variable size Fast Fourier Convolutions, while using fixed-size physical hardware (e.g., deep learning accelerators). In certain embodiments, the system 100 may receive an input signal containing content in a spatial domain, such as an input image, and chunk or divide the content into equally sized and partially overlapping content patches. The content patches may be transformed to the frequency domain, multiplied by a frequency domain filter, and then transformed back to the spatial domain. In certain embodiments, the convolved image patches may then be reassembled or reconstructed into the original content (i.e., the input image).

In certain embodiments, a system for providing efficient hardware-accelerated neural network convolution is provided. In certain embodiments, the system may include a memory and a deep learning accelerator configured to execute instructions from the memory. In certain embodiments, the system 100 may be configured to receive, by utilizing a neural network, an input image for use in an artificial intelligence task. The input image, for example, may be an image of an object in an environment, and may be in a spatial domain. In certain embodiments, the system 100 may be configured to divide the image into equally-sized partially overlapping image patches. In certain embodiments, the system 100 may be configured to apply a Fast Fourier Transform to each of the equally-sized partially overlapping image patches. In certain embodiments, the system 100 may be configured to adjust an image filter size of an image filter to correspond to a size of each of the equally-sized partially overlapping image patches. In certain embodiments, the system 100 may be configured to compute, for each pixel in each image patch of the equally-size partially overlapping image patches, a matrix-vector product between at least one channel of each image patch and a matrix from a corresponding pixel location in the image filter. In certain embodiments, the system 100 may be configured to apply an inverse Fast Fourier Transform to the matrix-vector product for each pixel in each image patch to convert each image patch to a spatial domain from a frequency domain. In certain embodiments, the system 100 may be configured to reconstruct, after application of the inverse Fast Fourier Transform, a convolved version of the input image by summing overlapping portions of each image patch together (e.g., by utilizing overlap-add algorithms). In certain embodiments, the system 100 may be configured to output the convolved version of the input image and perform the artificial intelligence task (e.g., a computer vision task, such as image classification) using the convolved version of the input image that is outputted.

In certain embodiments, the system 100 may be further configured to pad the image filter with zeroes until the image filter size of the image filter is adjusted to correspond to the size of each of the equally-sized partially overlapping image patches. In certain embodiments, the system may be further configured to apply the Fast Fourier Transform to the image filter prior to computation of the matrix-vector product. In certain embodiments, the equally-sized partially overlapping image patches may correspond to a frequency domain after application of the Fast Fourier Transform to each of the equally-sized partially overlapping image patches. In certain embodiments, the input image received by utilizing the neural network may correspond to the spatial domain. In certain embodiments, the system 100 may be further configured to determine a size of the overlapping portions based on the image filter size of the image filter. In certain embodiments, the system 100 may be further configured to generate mappings between first channels of the input image onto second channels of the convolved version of the input image. In certain embodiments, the system 100 may be further configured to cache frequency domain versions of the equally-sized partially overlapping image patches after application of the Fast Fourier Transform to the equally-sized partially overlapping image patches. In certain embodiments, the system 100 may be further configured to reuse the cached frequency domain versions of the equally-sized partially overlapping image patches in a convolutional layer.

In certain embodiments, a device, such as a memory device, integrated circuit, or processor including a deep learning accelerator to perform the operative functionality of the present disclosure is provided. In certain embodiments, the device may include a deep learning accelerator that may be configured to divide an input image into equally-sized partially overlapping image patches. In certain embodiments, the deep learning accelerator may be configured to apply a Fast Fourier Transform to each of the equally-sized partially overlapping image patches. In certain embodiments, the deep learning accelerator may be configured to modify an image filter size of an image filter to correspond to a size of each of the equally-sized partially overlapping image patches. In certain embodiments, the deep learning accelerator may be configured to apply the Fast Fourier Transform to the image filter after adjustment of the image filter size. In certain embodiments, the deep learning accelerator may be configured to compute, for each pixel in each image patch of the equally-size partially overlapping image patches, a matrix-vector product between at least one channel of each image patch and a matrix from a corresponding pixel location in the image filter. In certain embodiments, the deep learning accelerator may be configured to apply an inverse Fast Fourier Transform to the matrix-vector product for each pixel in each image patch to convert each image patch to a spatial domain. In certain embodiments, the deep learning accelerator may be configured to reconstruct, after application of the inverse Fast Fourier Transform, a convolved version of the input image by discarding overlapping regions of the image patches.

In certain embodiments, the deep learning accelerator may be further configured to facilitate reconstruction of the convolved version of the input image by copying retained portions of the image patches. In certain embodiments, the deep learning accelerator may be further configured to facilitate reconstructions of the convolved version of the input image by combining the retained portions of the image patches with each other to generate the reconstructed convolved image. In certain embodiments, the deep learning accelerator may be further configured to output the reconstructed convolved image. In certain embodiments, the deep learning accelerator may be further configured to adjust the image filter size by padding the image filter with zeroes until the image filter size corresponds to the size of each of the equally-sized partially overlapping image patches. In certain embodiments, the deep learning accelerator may be further configured to receive, by utilizing a neural network, the input image for use for an artificial intelligence task.

In certain embodiments, an exemplary method for providing efficient hardware-accelerated neural network convolution is provided. The method may include receiving, by utilizing a neural network, an input image (or other content) for use in an artificial intelligence task. In certain embodiments, the method may also include splitting the image into partially overlapping image patches. In certain embodiments, the method may include applying, by utilizing a deep learning accelerator, a Fast Fourier Transform to each of the partially overlapping image patches and to an image filter. In certain embodiments, the method may include computing, for each pixel in each image patch of partially overlapping image patches, a matrix-vector product between at least one channel of each image patch and a matrix from a corresponding pixel location in the image filter. In certain embodiments, the method may include applying an inverse Fast Fourier Transform to the matrix-vector product for each pixel in each image patch to convert each image patch to a spatial domain. In certain embodiments, the method may include reconstructing, after application of the inverse Fast Fourier Transform, a convolved version of the input image. In certain embodiments, the method may include applying a Fast Fourier Transform to the image filter to convert the filter to a frequency domain. In certain embodiments, the method may include reconstructing the convolved version of the input image by discarding overlapping regions of the image patches and combining the retained portions of the image patches, or by summing the overlapping regions of the image patches together.

In terms of performance, for some filter sizes, the functionality provided by the system 100 of the present disclosure can enable up to 3× fewer operations than conventional Fourier convolution, while also providing efficiency increases versus naïve convolution. For example, for an N×N image (N being measured in pixels or other unit), an M×M filter (M being measured in pixels or other unit), and N_{patch}×N_{patch} image patches (N_{patch} being measured in pixels or other unit), where N>>M and N>N_{patch}, naïve convolution may require 2N²M² floating point operations, while the system 100 incorporating overlap-save algorithms may require only 10N²N_{patch}²(log₂(N_{patch})+1/(N_{patch}^{-M+1})² operations. As an example, for a 512×512 input image, 9×9 filter, and 64×64 image patches, the system 100 incorporating overlap-save algorithm functionality may use 43.6% fewer operations than naïve convolution. Additionally, in certain embodiments, the cost of the forward Fast Fourier Transforms utilized by the system 100 may be amortized by reusing the frequency transforms generated in the system (e.g., a DenseNet neural network architecture may have potential efficiency improvements that are even far greater). Based on the foregoing and the remaining description, the system 100 is able to compute convolutions more quickly and efficiently, while using less energy that existing technologies. Furthermore, in certain embodiments, the functionality provided by the system 100 may also require less physical chip space.

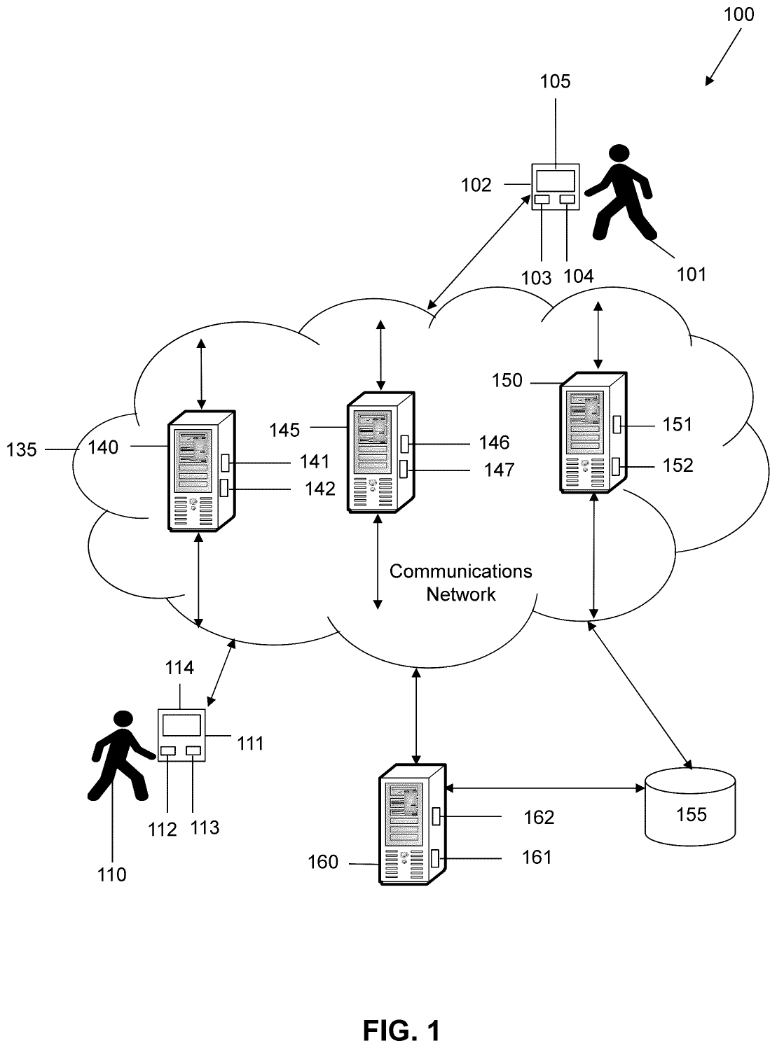

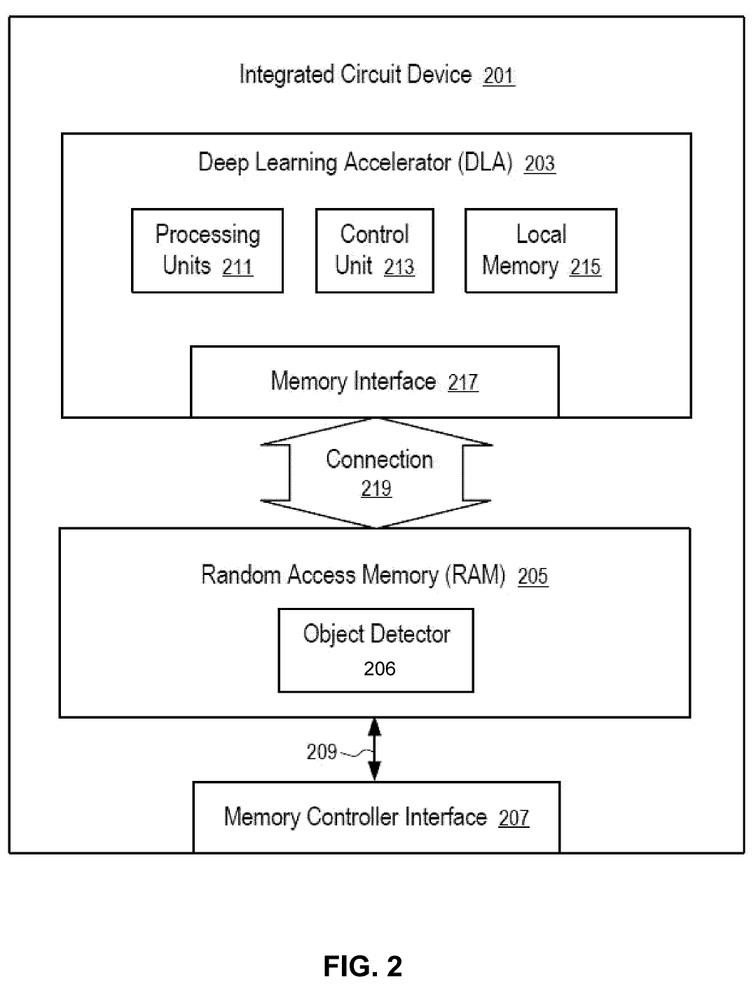

As shown in FIG. 1 and referring also to FIGS. 2-9, a system 100 for providing efficient hardware-accelerated neural network convolution is provided. Notably, the system 100 may be configured to support, but is not limited to supporting, neural network optimization systems and services, artificial intelligence optimization systems and services, image and/or content processing systems and services, analytics systems and services, data collation and processing systems and services, artificial intelligence services and systems, machine learning services and systems, neural network services, vision transformer-based services, convolutional neural network (CNN)-based services, mobile applications and services, content delivery services, cloud computing services, satellite services, telephone services, voice-over-internet protocol services (VoIP), software as a service (SaaS) applications, platform as a service (PaaS) applications, gaming applications and services, social media applications and services, operations management applications and services, productivity applications and services, and/or any other computing applications and services. Notably, the system 100 may include a first user 101, who may utilize a first user device 102 to access data, content, and services, or to perform a variety of other tasks and functions. As an example, the first user 101 may utilize first user device 102 to transmit signals to access various online services and content, such as those available on an internet, on other devices, and/or on various computing systems. As another example, the first user device 102 may be utilized to access an application, devices, and/or components of the system 100 that provide any or all of the operative functions of the system 100. In certain embodiments, the first user 101 may be a person, a robot, a humanoid, a program, a computer, any type of user, or a combination thereof, that may be located in a particular environment. In certain embodiments, the first user 101 may be a person that may want to utilize the first user device 102 to conduct various types of artificial intelligence tasks, such as by utilizing neural networks and machine learning. For example, such tasks may be computer vision tasks, such as, but not limited to, image classification, object detection, image segmentation, among other computer vision tasks. For example, the first user 101 may seek to identify or classify objects existing within an environment and the first user 101 may take images and/or video content of the environment, which may be processed by utilizing neural networks accessible by the first user device 102. As a further example, the first user 101 may be a person that may seek to process input images or other content more efficiently for use in artificial intelligence or other tasks.

The first user device 102 may include a memory 103 that includes instructions, and a processor 104 that executes the instructions from the memory 103 to perform the various operations that are performed by the first user device 102. In certain embodiments, the processor 104 may be hardware, software, or a combination thereof. The first user device 102 may also include an interface 105 (e.g. screen, monitor, graphical user interface, etc.) that may enable the first user 101 to interact with various applications executing on the first user device 102 and to interact with the system 100. In certain embodiments, the first user device 102 may be and/or may include a computer, any type of sensor, a laptop, a set-top-box, a tablet device, a phablet, a server, a mobile device, a smartphone, a smart watch, an autonomous vehicle, and/or any other type of computing device. Illustratively, the first user device 102 is shown as a smartphone device in FIG. 1. In certain embodiments, the first user device 102 may be utilized by the first user 101 to control and/or provide some or all of the operative functionality of the system 100. In certain embodiments, the first user device 102 may include and/or be communicatively linked or coupled to the integrated circuit device 201.

In addition to using first user device 102, the first user 101 may also utilize and/or have access to additional user devices. As with first user device 102, the first user 101 may utilize the additional user devices to transmit signals to access various online services and content, record various content, and/or access functionality provided by one or more neural networks. The additional user devices may include memories that include instructions, and processors that executes the instructions from the memories to perform the various operations that are performed by the additional user devices. In certain embodiments, the processors of the additional user devices may be hardware, software, or a combination thereof. The additional user devices may also include interfaces that may enable the first user 101 to interact with various applications executing on the additional user devices and to interact with the system 100. In certain embodiments, the first user device 102 and/or the additional user devices may be and/or may include a computer, any type of sensor, a laptop, a set-top-box, a tablet device, a phablet, a server, a mobile device, a smartphone, a smart watch, an autonomous vehicle, and/or any other type of computing device, and/or any combination thereof. Sensors may include, but are not limited to, cameras, motion sensors, acoustic/audio sensors, pressure sensors, temperature sensors, light sensors, any type of sensors, or a combination thereof. In certain embodiments, the sensors may be configured to generate content and/or data that may be processed using neural networks and/or artificial intelligence models of the system 100.

The first user device 102 and/or additional user devices may belong to and/or form a communications network. In certain embodiments, the communications network may be a local, mesh, or other network that enables and/or facilitates various aspects of the functionality of the system 100. In certain embodiments, the communications network may be formed between the first user device 102 and additional user devices through the use of any type of wireless or other protocol and/or technology. For example, user devices may communicate with one another in the communications network by utilizing any protocol and/or wireless technology, satellite, fiber, or any combination thereof. Notably, the communications network may be configured to communicatively link with and/or communicate with any other network of the system 100 and/or outside the system 100.

In certain embodiments, the first user device 102 and additional user devices belonging to the communications network may share and exchange data with each other via the communications network. For example, the user devices may share information relating to the various components of the user devices, information associated with images and/or content accessed and/or recorded by a user of the user devices, information associated conducting convolutions on the images and/or content, information associated with reconstructing images from image patches, information associated with outputs of artificial intelligence tasks using convolved images processed by deep learning accelerators and/or other devices of the system 100, information identifying the locations of the user devices, information indicating the types of sensors that are contained in and/or on the user devices, information identifying the applications being utilized on the user devices, information identifying how the user devices are being utilized by a user, information identifying user profiles for users of the user devices, information identifying device profiles for the user devices, information identifying the number of devices in the communications network, information identifying devices being added to or removed from the communications network, any other information, or any combination thereof.

In addition to the first user 101, the system 100 may also include a second user 110. The second user 110 may be similar to the first user 101, but may seek to do image classification, segmentation, and/or other computer vision-related tasks in a different or same environment and/or with a different user device, such as second user device 111. In certain embodiments, the second user 110 may be a user that may seek to automatically identify, classify, or segment objects in such an environment, such as by utilizing the functionality provided by the system 100. In certain embodiments, the second user device 111 may be utilized by the second user 110 to transmit signals to request various types of content, services, and data provided by and/or accessible by communications network 135 or any other network in the system 100. In further embodiments, the second user 110 may be a robot, a computer, a vehicle (e.g. semi or fully-automated vehicle), a humanoid, an animal, any type of user, or any combination thereof. The second user device 111 may include a memory 112 that includes instructions, and a processor 113 that executes the instructions from the memory 112 to perform the various operations that are performed by the second user device 111. In certain embodiments, the processor 113 may be hardware, software, or a combination thereof. The second user device 111 may also include an interface 114 (e.g. screen, monitor, graphical user interface, etc.) that may enable the first user 101 to interact with various applications executing on the second user device 111 and, in certain embodiments, to interact with the system 100. In certain embodiments, the second user device 111 may be a computer, a laptop, a set-top-box, a tablet device, a phablet, a server, a mobile device, a smartphone, a smart watch, an autonomous vehicle, and/or any other type of computing device. Illustratively, the second user device 111 is shown as a mobile device in FIG. 1. In certain embodiments, the second user device 111 may also include sensors, such as, but are not limited to, cameras, audio sensors, motion sensors, pressure sensors, temperature sensors, light sensors, humidity sensors, any type of sensors, or a combination thereof.

In certain embodiments, the first user device 102, the additional user devices, and/or the second user device 111 may have any number of software functions, applications and/or application services stored and/or accessible thereon. For example, the first user device 102, the additional user devices, and/or the second user device 111 may include applications for controlling and/or accessing the operative features and functionality of the system 100, applications for accessing and/or utilizing neural networks of the system 100, applications for controlling and/or accessing any device of the system 100, image processing applications, content processing applications, interactive social media applications, biometric applications, cloud-based applications, VoIP applications, other types of phone-based applications, product-ordering applications, business applications, e-commerce applications, media streaming applications, content-based applications, media-editing applications, database applications, gaming applications, internet-based applications, browser applications, mobile applications, service-based applications, productivity applications, video applications, music applications, social media applications, any other type of applications, any types of application services, or a combination thereof. In certain embodiments, the software applications may support the functionality provided by the system 100 and methods described in the present disclosure. In certain embodiments, the software applications and services may include one or more graphical user interfaces so as to enable the first and/or second users 101, 110 to readily interact with the software applications. The software applications and services may also be utilized by the first and/or second users 101, 110 to interact with any device in the system 100, any network in the system 100, or any combination thereof. In certain embodiments, the first user device 102, the additional user devices, and/or potentially the second user device 111 may include associated telephone numbers, device identities, or any other identifiers to uniquely identify the first user device 102, the additional user devices, and/or the second user device 111.

The system 100 may also include a communications network 135. The communications network 135 may be under the control of a service provider, the first user 101, any other designated user, a computer, another network, or a combination thereof. The communications network 135 of the system 100 may be configured to link each of the devices in the system 100 to one another. For example, the communications network 135 may be utilized by the first user device 102 to connect with other devices within or outside communications network 135. Additionally, the communications network 135 may be configured to transmit, generate, and receive any information and data traversing the system 100. In certain embodiments, the communications network 135 may include any number of servers, databases, or other componentry. The communications network 135 may also include and be connected to a neural network, a mesh network, a local network, a cloud-computing network, an IMS network, a VoIP network, a security network, a VoLTE network, a wireless network, an Ethernet network, a satellite network, a broadband network, a cellular network, a private network, a cable network, the Internet, an internet protocol network, MPLS network, a content distribution network, any network, or any combination thereof. Illustratively, servers 140, 145, and 150 are shown as being included within communications network 135. In certain embodiments, the communications network 135 may be part of a single autonomous system that is located in a particular geographic region, or be part of multiple autonomous systems that span several geographic regions.

Notably, the functionality of the system 100 may be supported and executed by using any combination of the servers 140, 145, 150, and 160. The servers 140, 145, and 150 may reside in communications network 135, however, in certain embodiments, the servers 140, 145, 150 may reside outside communications network 135. The servers 140, 145, and 150 may provide and serve as a server service that performs the various operations and functions provided by the system 100. In certain embodiments, the server 140 may include a memory 141 that includes instructions, and a processor 142 that executes the instructions from the memory 141 to perform various operations that are performed by the server 140. The processor 142 may be hardware, software, or a combination thereof. Similarly, the server 145 may include a memory 146 that includes instructions, and a processor 147 that executes the instructions from the memory 146 to perform the various operations that are performed by the server 145. Furthermore, the server 150 may include a memory 151 that includes instructions, and a processor 152 that executes the instructions from the memory 151 to perform the various operations that are performed by the server 150. In certain embodiments, the servers 140, 145, 150, and 160 may be network servers, routers, gateways, switches, media distribution hubs, signal transfer points, service control points, service switching points, firewalls, routers, edge devices, nodes, computers, mobile devices, or any other suitable computing device, or any combination thereof. In certain embodiments, the servers 140, 145, 150 may be communicatively linked to the communications network 135, any network, any device in the system 100, or any combination thereof.

The database 155 of the system 100 may be utilized to store and relay information that traverses the system 100, cache content that traverses the system 100, store data about each of the devices in the system 100 and perform any other typical functions of a database. In certain embodiments, the database 155 may be connected to or reside within the communications network 135, any other network, or a combination thereof. In certain embodiments, the database 155 may serve as a central repository for any information associated with any of the devices and information associated with the system 100. Furthermore, the database 155 may include a processor and memory or may be connected to a processor and memory to perform the various operations associated with the database 155. In certain embodiments, the database 155 may be connected to the servers 140, 145, 150, 160, the first user device 102, the second user device 111, the additional user devices, the integrated circuit device 201, the artificial neural network 301, the deep learning accelerator compiler 303, the random access memory 205, the deep learning accelerator 203, any devices in the system 100, any process of the system 100, any program of the system 100, any other device, any network, or any combination thereof.

The database 155 may also store information and metadata obtained from the system 100, store metadata and other information associated with the first and second users 101, 110, store information relating to tasks to be performed by artificial intelligence models and/or modules, store artificial intelligence/neural network models utilized in the system 100, store input images (or other content) received by the system 100, store image patches divided out from input images, store frequency domain versions and/or spatial domain versions of images (or other content) and/or image patches, store Fast Fourier Transform algorithms, store overlap-add algorithms, store overlap-save algorithms, store any other algorithms, store convolved versions of images (or other content), store outputs of artificial intelligence tasks generated based on the convolved versions of the images (or other content), store sensor data and/or content obtained from an environment, store predictions made by the system 100 and/or artificial intelligence/neural network models, storing confidence scores relating to predictions made, store threshold values for confidence scores, responses outputted and/or facilitated by the system 100 and, store information associated with anything detected via the system 100, store information and/or content utilized to train the artificial intelligence/neural network models, store user profiles associated with the first and second users 101, 110, store device profiles associated with any device in the system 100, store communications traversing the system 100, store user preferences, store information associated with any device or signal in the system 100, store information relating to patterns of usage relating to the user devices 102, 111, store any information obtained from any of the networks in the system 100, store historical data associated with the first and second users 101, 110, store device characteristics, store information relating to any devices associated with the first and second users 101, 110, store information associated with the communications network 135, store any information generated and/or processed by the system 100, store any of the information disclosed for any of the operations and functions disclosed for the system 100 herewith, store any information traversing the system 100, or any combination thereof. Furthermore, the database 155 may be configured to process queries sent to it by any device in the system 100.

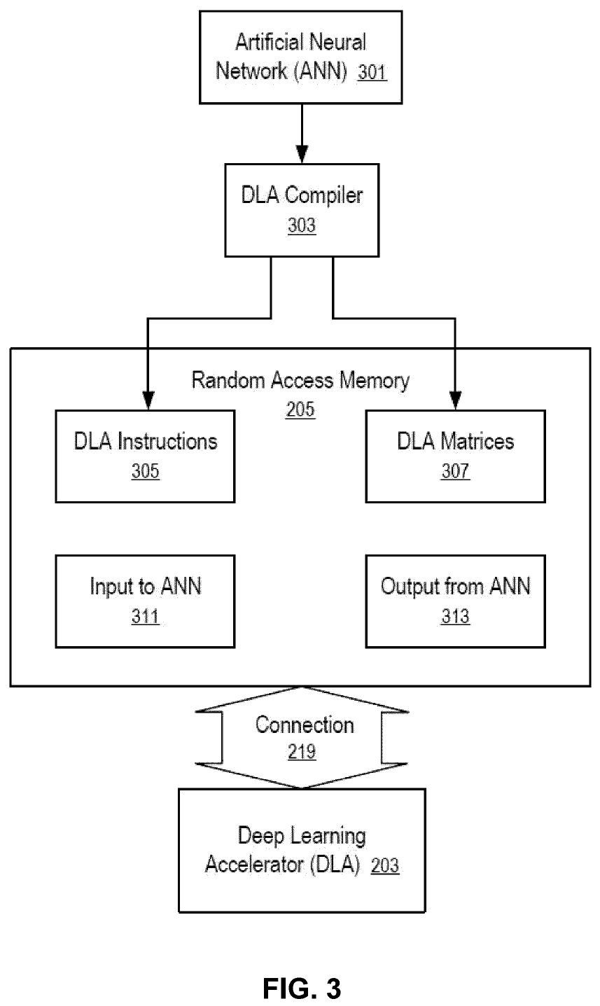

Referring now also to FIG. 2, an exemplary integrated circuit device 201 and accompanying componentry that may be utilized by a neural network, modules, and models of the present disclosure to facilitate efficient hardware-accelerated neural network convolution is provided. In certain embodiments, the integrated circuit device 201 may include a deep learning accelerator 203 and a memory 205 (e.g., random access memory or other memory). In certain embodiments, the deep learning accelerator 203 may be hardware and may have specifications and features designed to accelerate artificial intelligence and machine learning processes and enhance performance of artificial intelligence models and modules contained therein. In certain embodiments, the deep learning accelerator 203 may be configured to accelerate deep learning workloads and computations. In certain embodiments, the memory 205 may include an object detector 206. For example, the object detector 206 may include a neural network structure. In certain embodiments, a description of the object detector 206 may be compiled by a compiler to generate instructions for execution by the deep learning accelerator 203 and matrices to be used by the instructions. In certain embodiments, the object detector 206 in the memory 205 may include the instructions 305 and the matrices 307 generated by the compiler 303, as further discussed below in connection with FIG. 3. In certain embodiments, the deep learning accelerator 203 may include processing units 211, a control unit 213, and local memory 215. When vector and matrix operands are in the local memory 215, the control unit 213 may use the processing units 211 to perform vector and matrix operations in accordance with instructions. In certain embodiments, the control unit 213 can load instructions and operands from the memory 205 through a memory interface 217 and a high speed bandwidth connection 219.

In certain embodiments, the integrated circuit device 201 may be configured to be enclosed within an integrated circuit package with pins or contacts for a memory controller interface 207. In certain embodiments, the memory controller interface 207 may be configured to support a standard memory access protocol such that the integrated circuit device 201 appears to a typical memory controller in a way same as a conventional random access memory device having no deep learning accelerator 203. For example, a memory controller external to the integrated circuit device 201 may access, using a standard memory access protocol through the memory controller interface 207, the memory 205 in the integrated circuit device 201. In certain embodiments, the integrated circuit device 201 may be configured with a high bandwidth connection 219 between the memory 205 and the deep learning accelerator 203 that are enclosed within the integrated circuit device 201. In certain embodiments, bandwidth of the connection 219 is higher than the bandwidth of the connection 209 between the random access memory 205 and the memory controller interface 207.

In certain embodiments, both the memory controller interface 207 and the memory interface 217 may be configured to access the memory 205 via a same set of buses or wires. In certain embodiments, the bandwidth to access the memory 205 may be shared between the memory interface 217 and the memory controller interface 207. In certain embodiments, the memory controller interface 207 and the memory interface 217 may be configured to access the memory 205 via separate sets of buses or wires. In certain embodiments, the memory 205 may include multiple sections that can be accessed concurrently via the connection 219. For example, when the memory interface 217 is accessing a section of the memory 205, the memory controller interface 207 may concurrently access another section of the memory 205. For example, the different sections can be configured on different integrated circuit dies and/or different planes/banks of memory cells; and the different sections can be accessed in parallel to increase throughput in accessing the memory 205. For example, the memory controller interface 207 may be configured to access one data unit of a predetermined size at a time; and the memory interface 217 is configured to access multiple data units, each of the same predetermined size, at a time.

In certain embodiments, the memory 205 and the integrated circuit device 201 may be configured on different integrated circuit dies configured within a same integrated circuit package. In certain embodiments, the memory 205 may be configured on one or more integrated circuit dies that allows parallel access of multiple data elements concurrently. In certain embodiments, the number of data elements of a vector or matrix that may be accessed in parallel over the connection 219 corresponds to the granularity of the deep learning accelerator operating on vectors or matrices. For example, when the processing units 211 may operate on a number of vector/matrix elements in parallel, the connection 219 may be configured to load or store the same number, or multiples of the number, of elements via the connection 219 in parallel. In certain embodiments, the data access speed of the connection 219 may be configured based on the processing speed of the deep learning accelerator 203. For example, after an amount of data and instructions have been loaded into the local memory 215, the control unit 213 may execute an instruction to operate on the data using the processing units 211 to generate output. Within the time period of processing to generate the output, the access bandwidth of the connection 219 may allow the same amount of data and instructions to be loaded into the local memory 215 for the next operation and the same amount of output to be stored back to the random access memory 205. For example, while the control unit 213 is using a portion of the local memory 215 to process data and generate output, the memory interface 217 can offload the output of a prior operation into the random access memory 205 from, and load operand data and instructions into, another portion of the local memory 215. Thus, the utilization and performance of the deep learning accelerator 203 may not be restricted or reduced by the bandwidth of the connection 219.

In certain embodiments, the memory 205 may be used to store the model data of a neural network and to buffer input data for the neural network. The model data may include the output generated by a compiler for the deep learning accelerator 203 to implement the neural network. The model data may include matrices used in the description of the neural network and instructions generated for the deep learning accelerator 203 to perform vector/matrix operations of the neural network based on vector/matrix operations of the granularity of the deep learning accelerator 203. The instructions may operate not only on the vector/matrix operations of the neural network, but also on the input data for the neural network. In certain embodiments, when the input data is loaded or updated in the memory 205, the control unit 213 of the deep learning accelerator 203 may automatically execute the instructions for the neural network to generate an output for the neural network. The output may be stored into a predefined region in the memory 205. The deep learning accelerator 203 may execute the instructions without help from a central processing unit (CPU). Thus, communications for the coordination between the deep learning accelerator 203 and a processor outside of the integrated circuit device 201 (e.g., a Central Processing Unit (CPU)) can be reduced or eliminated. In certain embodiments, the deep learning accelerator 203 may be configured to perform the operative functionality of the system 100, the method 700, the method 800, or a combination thereof.

In certain embodiments, the memory 205 can be volatile memory or non-volatile memory, or a combination of volatile memory and non-volatile memory. Examples of non-volatile memory include flash memory, memory cells formed based on negative-and (NAND) logic gates, negative-or (NOR) logic gates, Phase-Change Memory (PCM), magnetic memory (MRAM), resistive random-access memory, cross point storage and memory devices. A cross point memory device can use transistor-less memory elements, each of which has a memory cell and a selector that are stacked together as a column. Memory element columns are connected via two lays of wires running in perpendicular directions, where wires of one lay run in one direction in the layer that is located above the memory element columns, and wires of the other lay run in another direction and are located below the memory element columns. Each memory element can be individually selected at a cross point of one wire on each of the two layers. Cross point memory devices are fast and non-volatile and can be used as a unified memory pool for processing and storage. Further examples of non-volatile memory include Read-Only Memory (ROM), Programmable Read-Only Memory (PROM), Erasable Programmable Read-Only Memory (EPROM) and Electronically Erasable Programmable Read-Only Memory (EEPROM) memory, etc. Examples of volatile memory include Dynamic Random-Access Memory (DRAM) and Static Random-Access Memory (SRAM).

For example, non-volatile memory can be configured to implement at least a portion of the memory 205. The non-volatile memory in the memory 205 may be used to store the model data of a neural network. Thus, after the integrated circuit device 201 is powered off and restarts, it is not necessary to reload the model data of the neural network into the integrated circuit device 201. Further, the non-volatile memory may be programmable/rewritable. Thus, the model data of the neural network in the integrated circuit device 201 may be updated or replaced to implement an updated neural network or another neural network.

Referring now also to FIG. 3, an exemplary deep learning accelerator 203 and memory 205 configured to apply inputs to a trained artificial neural network for performing tasks is shown. In certain embodiments, an artificial neural network 301 may be trained through machine learning (e.g., deep learning) to implement an artificial intelligence model and modules included therein. A description of the trained artificial neural network 301 in a standard format may identify the properties of the artificial neurons and their connectivity. In certain embodiments, the compiler 303 may convert trained artificial neural network 301 by generating instructions 305 for a deep learning accelerator 203 and matrices 307 corresponding to the properties of the artificial neurons and their connectivity. In certain embodiments, the instructions 305 and the matrices 307 generated by the compiler 303 from the trained artificial neural network 301 may be stored in memory 205 for the deep learning accelerator 203. For example, the memory 205 and the deep learning accelerator 203 may be connected via a high bandwidth connection 219 in a way as in the integrated circuit device 201. The computations of the artificial neural network 301 may be based on the instructions 305 and the matrices 307 may be implemented in the integrated circuit device 201. In certain embodiments, the memory 205 and the deep learning accelerator 203 may be configured on a printed circuit board with multiple point to point serial buses running in parallel to implement the connection 219.

In certain embodiments, after the results of the compiler 303 are stored in the memory 205, the application of the trained artificial neural network 301 to process an input 311 to the trained artificial neural network 301 to generate the corresponding output 313 of the trained artificial neural network 301 may be triggered by the presence of the input 311 in the memory 205, or another indication provided in the memory 205. In response, the deep learning accelerator 203 executes the instructions 305 to combine the input 311 and the matrices 307. The matrices 307 may include kernel matrices to be loaded into kernel buffers and maps matrices to be loaded into maps banks. The execution of the instructions 305 can include the generation of maps matrices for the maps banks of one or more matrix-matrix units of the deep learning accelerator 203. In certain embodiments, the inputs to artificial neural network 301 is in the form of an initial maps matrix. Portions of the initial maps matrix can be retrieved from the memory 205 as the matrix operand stored in the maps banks of a matrix-matrix unit. In certain embodiments, the instructions 305 also include instructions for the deep learning accelerator 203 to generate the initial maps matrix from the input 311. Based on the instructions 305, the deep learning accelerator 203 may load matrix operands into kernel buffers and maps banks of its matrix-matrix unit. The matrix-matrix unit performs the matrix computation on the matrix operands. For example, the instructions 305 break down matrix computations of the trained artificial neural network 301 according to the computation granularity of the deep learning accelerator 203 (e.g., the sizes/dimensions of matrices that loaded as matrix operands in the matrix-matrix unit) and applies the input feature maps to the kernel of a layer of artificial neurons to generate output as the input for the next layer of artificial neurons.

Upon completion of the computation of the trained artificial neural network 301 performed according to the instructions 305, the deep learning accelerator 203 may store the output 313 of the artificial neural network 301 at a pre-defined location in the memory 205, or at a location specified in an indication provided in the memory 205 to trigger the computation. In certain embodiments, an external device connected to the memory controller interface 207 can write the input 311 (e.g., an image) into the memory 205 and trigger the computation of applying the input 311 to the trained artificial neural network 301 by the deep learning accelerator 203. After a period of time, the output 313 (e.g., a classification) is available in the memory 205 and the external device can read the output 313 via the memory controller interface 207 of the integrated circuit device 201. For example, a predefined location in the memory 205 can be configured to store an indication to trigger the execution of the instructions 305 by the deep learning accelerator 203. The indication can include a location of the input 311 within the memory 205. Thus, during the execution of the instructions 305 to process the input 311, the external device can retrieve the output generated during a previous run of the instructions 305, and/or store another set of input for the next run of the instructions 305.

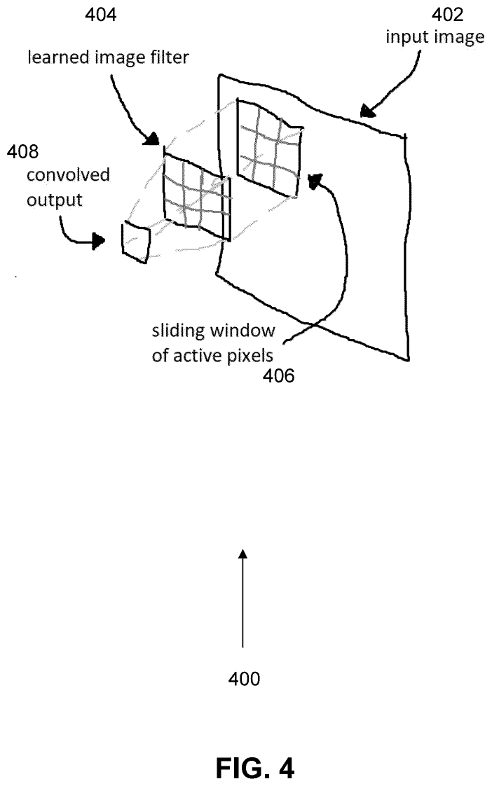

Referring now also to FIG. 4, an exemplary visual example 400 of a convolution that may be utilized with the system 100 is illustrated. In certain embodiments, in image convolution, a filter may be tiled across an input image 402 and applied repeatedly to the image until the entire image is traversed by the filter. For a single channel input image and a single channel output image, the image convolution may take the form of a vector-vector dot product between the current pixels in the sliding window 406 and the learned image filter 404. If, however, there are multiple image input channels (e.g., red channel, green channel, and blue channel) and multiple output channels, the sliding window 406 may be a matrix-vector product, wherein the learned image filter is a transformation matrix, and the current pixels in the sliding window are flattened into a vector. In certain embodiments, despite reading in multiple pixels into the image filter at each step of the process, the output 408 of the convolution window may be one pixel at a time.

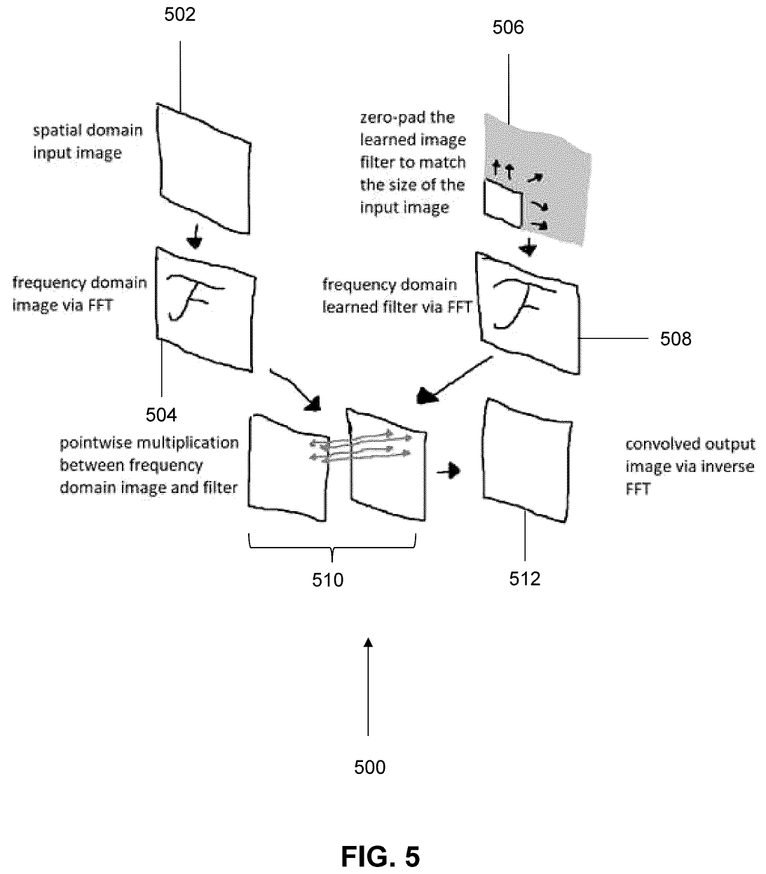

Referring now also to FIG. 5, an exemplary visual example 500 of a convolution involving application of a Fast Fourier Transform is illustrated. The mathematical theorem that indicates that pointwise multiplication in the spectral domain is exactly equivalent to convolution in the spatial domain is the convolution theorem, r(x)={g*h}(x)=F⁻¹ {G dot H], where dot denotes point-wise multiplication, and F is the Fourier transform operator. Since there are algorithms for computing the Fourier Transform, the system 100 can exploit the convolution theorem to computer convolutions more quickly without having to repeatedly tile the image filter over the input filter as in the example 400. To that end, in certain embodiments, a convolution via Fast Fourier Transform may be conducted in the following manner. An input image 502 may be received that is of the spatial domain. The system 100 may apply the Fast Fourier Transform 504 to the input image 502 (or other content) to convert to the frequency domain. In certain embodiments, the system 100 may proceed to take the learned image filter and pad the image filter with zeroes so that the image filter is the same spatial size as the input image, at 506. Then, the system 100 may apply the Fast Fourier Transform to the zero-padded learned image filter, at 508. The system 100 may proceed, at 510, to perform the pointwise multiplication between the frequency domain image and the frequency domain learned filter (i.e., that result based on application of the Fast Fourier Transforms). The system 100 may then apply the inverse Fast Fourier Transform to the pointwise product to obtain the spatial domain convolved image at 512.

In certain embodiments, the default method of Fast Fourier convolution may be sped up even further by applying overlap methods such as overlap-add or overlap-save. In certain embodiments, the overlap methods may decompose the convolution operation into smaller spatial chunks. By first chunking (or dividing) the input image before applying the Fast Fourier Transform, overlap-add/-save can achieve better efficiency when performing the transformations to and from the frequency domain, at the cost of slightly higher overhead due to the overlaps. In certain embodiments, the “overlap” in overlap-add and overlap-save may refer to the process of breaking the input signal into partially overlapping chunks (i.e., image patches). In certain embodiments, the overlap may be utilized to reconstruct the full-sized convolved image from the smaller image patches/chunks. In certain embodiments, the “add” in overlap-add may include joining the overlaps of different image chunks/patches through summation, which may exploit the linear additive property of convolutions. In certain embodiments, the “save” in overlap-save may refer to retaining the non-overlapping region of the input image signal, discarding the overlaps, and then copying the retained portions of the image patches next to each other in the output image. In certain embodiments, the overlap region may still be needed to compute the convolution of the retained area, even if the overlap itself is not kept in the output. In certain embodiments, such a scenario may be called “overlap-discard.” In certain embodiments, the size of the overlaps may be determined by the size of the learned image filter.

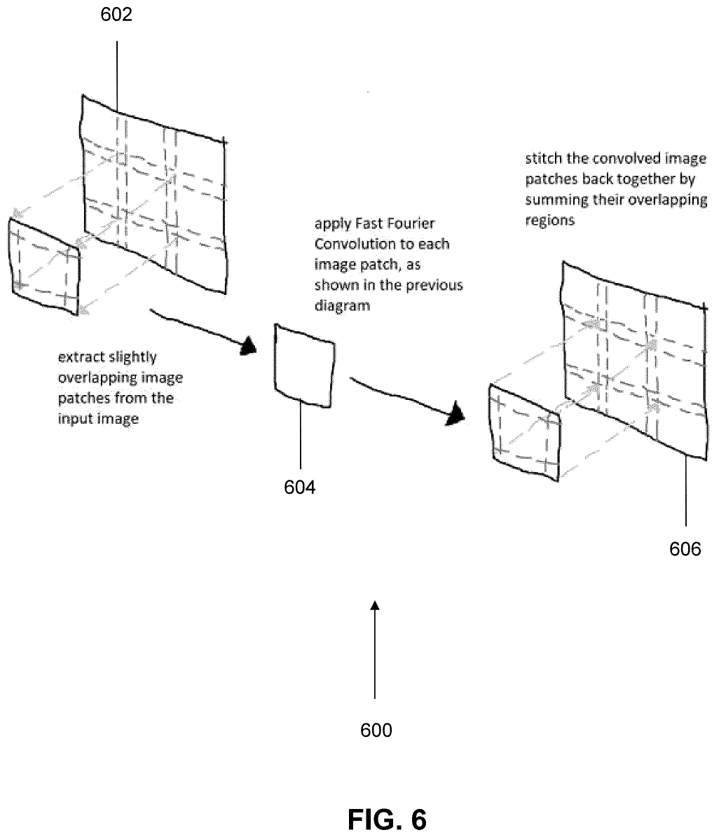

Referring now also to FIG. 6, an exemplary visual example 600 of convolution incorporating overlap-add is shown. In certain embodiments, convolution incorporating overlap-add may operate in the following manner. In certain embodiments, at 602, the convolution may entail breaking up the input image into multiple regularly-sized image patches, which may overlap by an equal number of pixels to the filter width. In certain embodiments, using the above-described Fourier convolution technique, at 604, each image patch may be convolved by the system 100 separately. Then, at 606, the system 100 may proceed to reconstruct the original-size convolved image by summing the overlapping regions of the convolved image patches back together.

According to embodiments of the present disclosure hardware overlap-add or save may be utilized for deep learning inference. Notably, not only are overlap-add and overlap-save algorithmically faster than both naïve convolution and Fourier convolution for many filter sizes but overlap-add and overlap-save also make it practical to implement Fast Fourier convolution in physical hardware, such as in deep learning accelerators 203. In certain embodiments, ordinary Fast Fourier convolution may require a different calculation for different sized inputs, making hardware implementations of the algorithm impractical. However, overlap-add and/or overlap-save makes it possible to break up a variable-sized input image into constant-sized image patches that can be processed in fixed-size hardware. In certain embodiments, having larger input images would simply mean processing a larger number of constant-sized image (or content) patches. In certain embodiments, the lower algorithmic complexity of overlap-add and/or overlap-save vs. naïve convolution may also translate to requiring less physical space on a die when implemented as a hardware logic circuit, as well as requiring less power consumption. Computational complexity for a single-channel variant may be as follows. In certain embodiments, for a single-channel naïve image convolution comprising an m×m input image and an n×n learned image filter, the convolution may require 2N²M² additions and multiplications. In certain embodiments, for a single-channel overlap-add image convolution comprising an N×N input image, an M×M learned image filter, and N_{patch}×N_{patch} image patches, a convolution may require require 10N² N_{patch}²(log₂(N_{patch})+1)/(N_{patch}−M+1)² additions and multiplications.

In certain embodiments, input images may typically contain multiple “channels” representing different types of data (e.g. separate red, green, blue channels), and thus convolution layers in deep neural networks may also contain mappings from multiple input image channels onto multiple output image channels. For each convolution operation, frequency domain convolution methods may have the input be both forward and inverse transformed, however, the system 100 is able to exploit the fact that the system 100 may perform convolution on multiple channels at the same time to reduce the number of forward and inverse transforms required through mathematical algorithms. In certain embodiments, if an input image comprising multiple channels is convolved by multiple filters, as may be the case for deep learning models, the forward transform of the input image channels, from the spatial domain to the frequency domain, may be cached and reused. In certain embodiments, reusing the forward transforms in a convolution layer with “i” input channels and “o” output channels, may reduce the required number of forward transforms to O(i) instead of O(i*o). In certain embodiments, the efficiency of the convolution operation may be improved further still by exploiting the fact that addition in the frequency domain is equivalent to addition in the spatial domain, making it possible to sum the convolved image channels in the frequency domain and only perform a single inverse transform for each output channel. In certain embodiments, for a convolution layer with “i” input channels and “o” output channels, this may reduce the number of required inverse transforms to O(o) instead of O(i*o). In certain embodiments, in the exemplary case of a convolutional layer with 64 input channels and 64 output channels, this would reduce the number of forward and inverse transforms by 64×. As a result, the system 100 functionality greatly improves the efficiency of the algorithm in comparison to computing the convolutions independently from one another.

In certain embodiments, an inference flow for an improved convolution layer variant may operate as follows. In certain embodiments, the system 100 may break or divide the input image into regularly sized (e.g. 64×64) overlapping patches and apply the Fast Fourier Transform to each image patch. In certain embodiments, the system 100 may take the learned image filter and pad the image filter with zeroes so that the image filter is the same spatial size as the image patches. The system 100 may then apply the Fast Fourier Transform to the zero-padded learned image filter, and, for each pixel, compute the matrix-vector product between the channels of the transformed image patch, and the matrix obtained from the corresponding pixel location in the transformed learned image filter. In certain embodiments, the system 100 may proceed to apply the inverse Fast Fourier Transform to the matrix-vector products, thereby converting the image patches back to the spatial domain. The system 100 may then proceed to digitally stitch or combine the convolved image patches back into the original image. In implementations utilizing the overlap-add variant, the system 100 may sum the overlapping edges of the image patches back together to do the combination. If, however, the system 100 is utilizing the overlap-save variant, the system 100 may discard the overlapping regions and combine the retained or remaining regions obtain the image.

In certain embodiments, for a naïve convolution layer including a N×N input image, a M×M learned image filter, N_{patch}×N_{patch} image patches, I input channels, and O output channels, a forward pass of the convolution layer may require 2N² M² IO additions and multiplications. In certain embodiments, for an amortized overlap-add convolution layer comprising an N×N input image, an M×M learned image filter, N_{patch}×N_{patch} image patches, I input channels, and O output channels, a forward pass of the convolution layer may require (I+O)10N² N_{patch}² (log₂(N_{patch})+1)/(N_{patch}−M+1)²+8IO M² additions and multiplications. Notably, other techniques and/or processes may be utilized to combine or digitally stich the convolved image patches back together besides overlap-add and overlap-save. Additionally, other techniques for performing frequency domain convolution besides Fast Fourier transform (e.g. the discrete cosine transform) may also be utilized to implement the functionality of the system 100.

Notably, as shown in FIG. 1, the system 100 may perform any of the operative functions disclosed herein by utilizing the processing capabilities of server 160, the storage capacity of the database 155, or any other component of the system 100 to perform the operative functions disclosed herein. The server 160 may include one or more processors 162 that may be configured to process any of the various functions of the system 100. The processors 162 may be software, hardware, or a combination of hardware and software. Additionally, the server 160 may also include a memory 161, which stores instructions that the processors 162 may execute to perform various operations of the system 100. For example, the server 160 may assist in processing loads handled by the various devices in the system 100, such as, but not limited to, receiving the input images (or other content) for use in an artificial intelligence task; dividing, chunking, or splitting the input image into overlapping image patches; applying Fast Fourier Transforms to each of the image patches, padding an image filter with zeroes until a size of the image filter corresponds to a size of each of the image patches; applying a Fast Fourier Transform to the zero-padded image filter; computing matrix-vector products between channels of each image patch and a matrix obtained from a corresponding pixel location in the zero-padded image filter; applying an inverse Fast Fourier Transform to the matrix-vector products for each pixel in each image patch to convert the image patches from the frequency domain to the spatial domain; reconstructing a convolved version of the input image by summing the overlapping portions (e.g., edges) of the image patches together or by discarding overlapping regions of the image patches and digitally stitching together the remaining or retained portions of the image patches; outputting the reconstructed convolved image, performing an artificial intelligence task using the reconstructed convolved image; and performing any other suitable operations conducted in the system 100 or otherwise. In certain embodiments, multiple servers 160 may be utilized to process the functions of the system 100. The server 160 and other devices in the system 100, may utilize the database 155 for storing data about the devices in the system 100 or any other information that is associated with the system 100. In one embodiment, multiple databases 155 may be utilized to store data in the system 100.

Although FIGS. 1-9 illustrates specific example configurations of the various components of the system 100, the system 100 may include any configuration of the components, which may include using a greater or lesser number of the components. For example, the system 100 is illustratively shown as including a first user device 102, a second user device 111, a communications network 135, a server 140, a server 145, a server 150, a server 160, a database 155, an integrated circuit device 201, a deep learning accelerator 203, a random access memory 205, a DLA compiler 303, an artificial neural network 301, and other components. However, the system 100 may include multiple first user devices 102, multiple second user devices 111, multiple communications networks 135, multiple servers 140, multiple servers 145, multiple servers 150, multiple servers 160, multiple databases 155, multiple integrated circuit devices 201, multiple deep learning accelerators 203, multiple random access memories 205, multiple DLA compilers 303, multiple artificial neural networks 301, and/or any number of any of the other components inside or outside the system 100. Similarly, the system 100 may include any number of any of the other components of any of the figures. Furthermore, in certain embodiments, substantial portions of the functionality and operations of the system 100 may be performed by other networks and systems that may be connected to system 100.

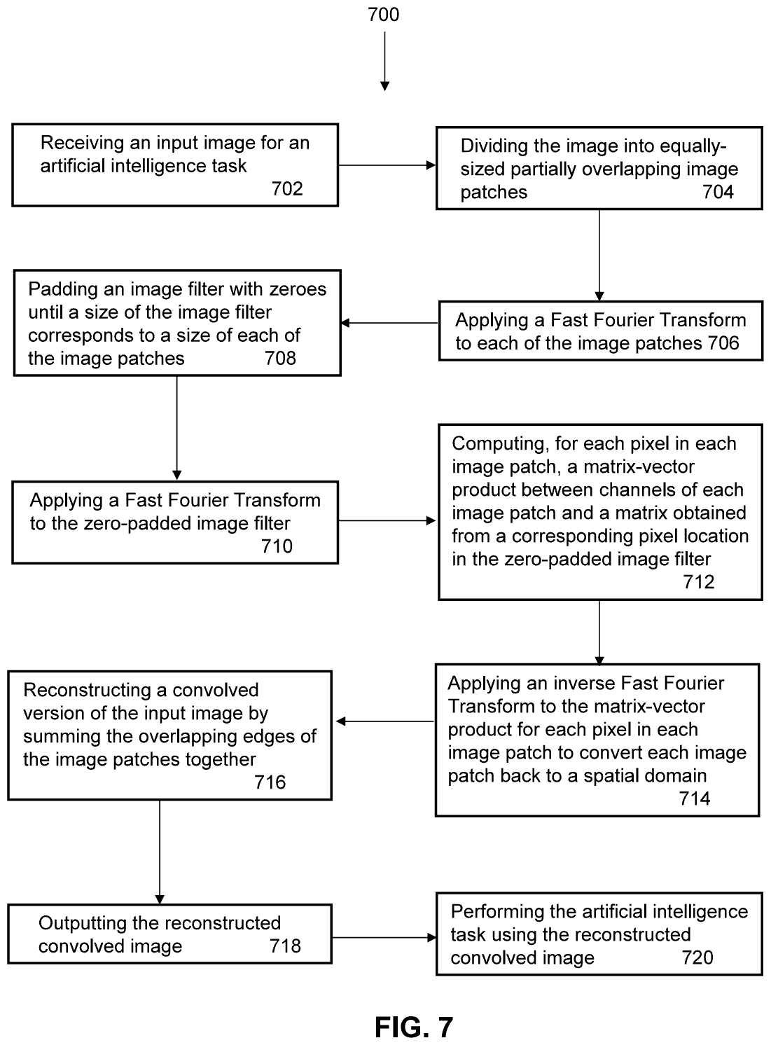

Referring now also to FIG. 7, FIG. 7 illustrates a method 700 for providing efficient hardware-accelerated neural network convolution according to embodiments of the present disclosure. For example, the method of FIG. 7 can be implemented in the system of FIG. 1 and/or any of the other systems, devices, and/or componentry illustrated in the Figures. In certain embodiments, the method of FIG. 7 can be performed by processing logic that can include hardware (e.g., processing device, circuitry, dedicated logic, programmable logic, microcode, hardware of a device, integrated circuit, deep learning accelerator, etc.), software (e.g., instructions run or executed on a processing device), or a combination thereof. In some embodiments, the method of FIG. 7 may be performed at least in part by one or more processing devices (e.g., processor 102, processor 112, processor 141, processor 146, processor 151, and processor 161 of FIG. 1 and/or by componentry of the integrated circuit device 201, such as, but not limited to, deep learning accelerator 203). Although shown in a particular sequence or order, unless otherwise specified, the order of the steps in the method 700 may be modified and/or changed depending on implementation and objectives. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

The method 700 may include steps for performing high efficiency convolutions by utilizing algorithmically fast algorithms (e.g., overlap-add, etc.) to facilitate faster processing of artificial intelligence tasks and also ensuring faster processing via physical hardware, such as by utilizing the algorithms to increase the speed of processing convolutions by taking advantage of characteristics, features, and/or functionality of deep learning accelerators 203. The method 700 may also include utilizing algorithms, such as, but not limited to, overlap-add and overlap-save algorithms for use in deep learning accelerators 203, while making it possible to efficiently compute variable size Fast Fourier (and/or other) convolutions using fixed-size physical hardware (e.g., deep learning accelerators 203, etc.). For example, the method 700 may include steps for dividing an input signal containing an image (or other content) in the spatial domain into equally-sized and partially overlapping patches, where the patches are then transformed to the frequency domain, multiplied by a frequency domain filter, and finally transformed back to the spatial domain, such as by utilizing an overlap-add algorithm. In certain embodiments, the method 700 may be performed by utilizing system 100, and/or by utilizing any combination of the componentry contained therein and any other systems and devices described herein.

At step 702, the method 700 may include receiving an input image (or other type of content), such as for use in an artificial intelligence task. The input image, for example, may be of an environment, an object located in an environment, any image, or a combination thereof. In certain embodiments, instead of an input image, the input may be video content, audio content, haptic content, vibration content, text content, augmented reality content, virtual reality content, any type of content, or a combination thereof. The artificial intelligence task, for example, may be a computer vision task, such as but not limited to, image classification (e.g., extracting features from image content and classifying and/or predicting the class of the image), object detection (e.g., identifying a certain class of image and then detect the presence of the image within image content), object tracking (e.g., tracking an object within an environment or media content once the object is detected), and content-based image retrieval (e.g., searching databases for content having similarity and/or correlation to content processed by the neural network), among other computer vision tasks. In certain embodiments, the input image may be obtained by utilizing a neural network, which may obtain the image from a sensor, a camera, a computing device, a system, an application, any other source of image content (or other types of content). In certain embodiments, the receiving of the input image (or other content) may be performed and/or facilitated by utilizing the first user device 102, the second user device 111, the server 140, the server 145, the server 150, the server 160, the communications network 135, the integrated circuit device 201, the deep learning accelerator 203, the artificial neural network 301, any component of the system 100, any combination thereof, or by utilizing any other appropriate program, network, system, or device.

At step 704, the method 700 may include dividing or splitting the image into a plurality of partially overlapping image patches. In certain embodiments, the input image may be divided into equally-sized partially overlapping image patches. In certain embodiments, the dividing or splitting of the input image into the overlapping image patches may be performed and/or facilitated by utilizing the first user device 102, the second user device 111, the server 140, the server 145, the server 150, the server 160, the communications network 135, the integrated circuit device 201, the deep learning accelerator 203, the artificial neural network 301, any component of the system 100, any combination thereof, or by utilizing any other appropriate program, network, system, or device. At step 706, the method 700 may include applying a Fast Fourier Transform (and/or other algorithm) to each of the image patches resulting from the dividing or splitting. In certain embodiments, the application of the Fast Fourier Transform (and/or other algorithm) may be performed and/or facilitated by utilizing the first user device 102, the second user device 111, the server 140, the server 145, the server 150, the server 160, the communications network 135, the integrated circuit device 201, the deep learning accelerator 203, the artificial neural network 301, any component of the system 100, any combination thereof, or by utilizing any other appropriate program, network, system, or device.

At step 708, the method 700 may include padding an image filter for use in convolving the input image by padding the image filter with zeroes until a size of the image filter corresponds to the size of each of the image patches. In certain embodiments, the padding of the image filter may be performed and/or facilitated by utilizing the first user device 102, the second user device 111, the server 140, the server 145, the server 150, the server 160, the communications network 135, the integrated circuit device 201, the deep learning accelerator 203, the artificial neural network 301, any component of the system 100, any combination thereof, or by utilizing any other appropriate program, network, system, or device. At step 710, the method 700 may include applying a Fast Fourier Transform to the padded image filter so that the padded image filter is in the frequency domain from the spatial domain of the original input image. In certain embodiments, the application of the Fast Fourier Transform to the padded image may be performed and/or facilitated by utilizing the first user device 102, the second user device 111, the server 140, the server 145, the server 150, the server 160, the communications network 135, the integrated circuit device 201, the deep learning accelerator 203, the artificial neural network 301, any component of the system 100, any combination thereof, or by utilizing any other appropriate program, network, system, or device.

At step 712, the method 700 may include computing, for each pixel in each image patch, a matrix-vector product between channels of each image patch and a matrix generated and/or obtained from a corresponding pixel location in the padded image filter. In certain embodiments, the computing of the matrix-vector product may be performed and/or facilitated by utilizing the first user device 102, the second user device 111, the server 140, the server 145, the server 150, the server 160, the communications network 135, the integrated circuit device 201, the deep learning accelerator 203, the artificial neural network 301, any component of the system 100, any combination thereof, or by utilizing any other appropriate program, network, system, or device. At step 714, the method 700 may include applying an inverse Fast Fourier Transform to the matrix-vector product for each pixel in each image to convert each image patch back to the spatial domain from the frequency domain. In certain embodiments, the application of the inverse Fast Fourier Transform may be performed and/or facilitated by utilizing the first user device 102, the second user device 111, the server 140, the server 145, the server 150, the server 160, the communications network 135, the integrated circuit device 201, the deep learning accelerator 203, the artificial neural network 301, any component of the system 100, any combination thereof, or by utilizing any other appropriate program, network, system, or device.

At step 716, the method 700 may include facilitating reconstruction of the convolved version of the input image corresponding to the original input image. In certain embodiments, the reconstructions may be conducted by summing the overlapping portions or edges of the image patches together and reconstructing the convolved image by combining the portions together. In certain embodiments, the reconstructing of the convolved version of the input image may be performed and/or facilitated by utilizing the first user device 102, the second user device 111, the server 140, the server 145, the server 150, the server 160, the communications network 135, the integrated circuit device 201, the deep learning accelerator 203, the artificial neural network 301, any component of the system 100, any combination thereof, or by utilizing any other appropriate program, network, system, or device. At step 718, the method 700 may include outputting the reconstructed convolved image corresponding to the original input image. In certain embodiments, the outputting of the reconstructed image may be performed and/or facilitated by utilizing the first user device 102, the second user device 111, the server 140, the server 145, the server 150, the server 160, the communications network 135, the integrated circuit device 201, the deep learning accelerator 203, the artificial neural network 301, any component of the system 100, any combination thereof, or by utilizing any other appropriate program, network, system, or device.

At step 720, the method 700 may include performing the artificial intelligence task using the reconstructed image corresponding to the original input image. For example, of the artificial intelligence task is a computer vision task, the system 100 may utilize the image to perform image classification, image segmentation, object detection, content-based image retrieval, other tasks, or a combination thereof. In certain embodiments, the performing of the artificial intelligence tasks may be performed and/or facilitated by utilizing the first user device 102, the second user device 111, the server 140, the server 145, the server 150, the server 160, the communications network 135, the integrated circuit device 201, the deep learning accelerator 203, the artificial neural network 301, any component of the system 100, any combination thereof, or by utilizing any other appropriate program, network, system, or device. In certain embodiments, the method 700 may be repeated as desired and/or by the system 100. Notably, the method 700 may incorporate any of the other functionality as described herein and may be adapted to support the functionality of the system 100.

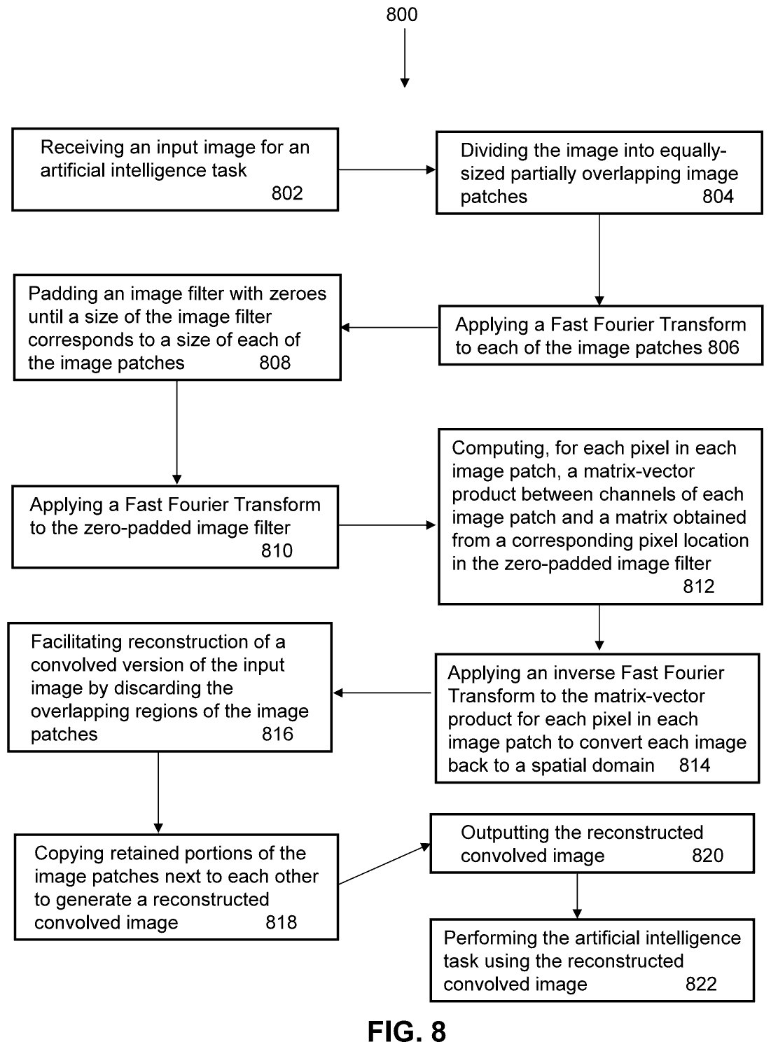

Referring now also to FIG. 8, FIG. 8 illustrates a method 800 for providing efficient hardware-accelerated neural network convolution according to embodiments of the present disclosure. For example, the method of FIG. 8 can be implemented in the system of FIG. 1 and/or any of the other systems, devices, and/or componentry illustrated in the Figures. In certain embodiments, the method of FIG. 8 can be performed by processing logic that can include hardware (e.g., processing device, circuitry, dedicated logic, programmable logic, microcode, hardware of a device, integrated circuit, deep learning accelerator, etc.), software (e.g., instructions run or executed on a processing device), or a combination thereof. In some embodiments, the method of FIG. 8 may be performed at least in part by one or more processing devices (e.g., processor 102, processor 112, processor 141, processor 146, processor 151, and processor 161 of FIG. 1 and/or by componentry of the integrated circuit device 201, such as, but not limited to, deep learning accelerator 203). Although shown in a particular sequence or order, unless otherwise specified, the order of the steps in the method 800 may be modified and/or changed depending on implementation and objectives. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

The method 800 may include steps for conducting higher efficiency convolutions by incorporating algorithmically faster algorithms (e.g. overlap-save, etc.), while also ensuring faster processing via physical hardware, such as by utilizing the algorithms to facilitate faster processing of convolutions based on the characteristics, features, and/or functionality of deep learning accelerators 203. The method 800 may also include utilizing algorithms, such as, but not limited to, overlap-add and overlap-save algorithms for use in deep learning accelerators 203, while making it possible to efficiently compute variable size Fast Fourier (and/or other) convolutions using fixed-size physical hardware (e.g., deep learning accelerators 203, etc.). For example, the method 800 may include steps for splitting or dividing an input signal containing an image (or other content) in the spatial domain into equally-sized and partially overlapping patches, where the patches are then transformed to the frequency domain, multiplied by a frequency domain filter, and finally transformed back to the spatial domain, such as by utilizing an overlap-save algorithm. In certain embodiments, the method 800 may be performed by utilizing system 100, and/or by utilizing any combination of the componentry contained therein and any other systems and devices described herein. At step 802, the method 800 may include receiving an input image (or other type of content) for an artificial intelligence task. The input image, for example, may be of an environment, an object located in an environment, any image, or a combination thereof. The artificial intelligence task, for example, may be a computer vision task, such as but not limited to, image classification (e.g., extracting features from image content and classifying and/or predicting the class of the image), object detection (e.g., identifying a certain class of image and then detect the presence of the image within image content), object tracking (e.g., tracking an object within an environment or media content once the object is detected), and content-based image retrieval (e.g., searching databases for content having similarity and/or correlation to content processed by the neural network), among other computer vision tasks. In certain embodiments, the input image may be obtained by utilizing a neural network, which may obtain the image from a sensor, a camera, a computing device, a system, an application, any other source of image content (or other types of content). In certain embodiments, the receiving of the input image (or other content) may be performed and/or facilitated by utilizing the first user device 102, the second user device 111, the server 140, the server 145, the server 150, the server 160, the communications network 135, the integrated circuit device 201, the deep learning accelerator 203, the artificial neural network 301, any component of the system 100, any combination thereof, or by utilizing any other appropriate program, network, system, or device.

At step 804, the method 800 may include dividing or splitting the image into partially overlapping image patches. In certain embodiments, the input image may be divided into equally-sized partially overlapping image patches. In certain embodiments, the dividing or splitting of the input image into the overlapping image patches may be performed and/or facilitated by utilizing the first user device 102, the second user device 111, the server 140, the server 145, the server 150, the server 160, the communications network 135, the integrated circuit device 201, the deep learning accelerator 203, the artificial neural network 301, any component of the system 100, any combination thereof, or by utilizing any other appropriate program, network, system, or device. At step 806, the method 800 may include applying a Fast Fourier Transform (and/or other algorithm) to each of the image patches resulting from the dividing or splitting. In certain embodiments, the application of the Fast Fourier Transform (and/or other algorithm) may be performed and/or facilitated by utilizing the first user device 102, the second user device 111, the server 140, the server 145, the server 150, the server 160, the communications network 135, the integrated circuit device 201, the deep learning accelerator 203, the artificial neural network 301, any component of the system 100, any combination thereof, or by utilizing any other appropriate program, network, system, or device.

At step 808, the method 800 may include padding an image filter for facilitating convolution of the input image by padding the image filter with zeroes until a size of the image filter corresponds to the size of each of the image patches. In certain embodiments, the padding of the image filter may be performed and/or facilitated by utilizing the first user device 102, the second user device 111, the server 140, the server 145, the server 150, the server 160, the communications network 135, the integrated circuit device 201, the deep learning accelerator 203, the artificial neural network 301, any component of the system 100, any combination thereof, or by utilizing any other appropriate program, network, system, or device. At step 810, the method 800 may include applying a Fast Fourier Transform to the padded image filter so that the image filter is in the frequency domain from the spatial domain of the original input image. In certain embodiments, the application of the Fast Fourier Transform to the padded image may be performed and/or facilitated by utilizing the first user device 102, the second user device 111, the server 140, the server 145, the server 150, the server 160, the communications network 135, the integrated circuit device 201, the deep learning accelerator 203, the artificial neural network 301, any component of the system 100, any combination thereof, or by utilizing any other appropriate program, network, system, or device.

At step 812, the method 800 may include computing, for each pixel in each image patch, a matrix-vector product between channels of each image patch and a matrix generated and/or obtained from a corresponding pixel location in the padded image filter. In certain embodiments, the computing of the matrix-vector product may be performed and/or facilitated by utilizing the first user device 102, the second user device 111, the server 140, the server 145, the server 150, the server 160, the communications network 135, the integrated circuit device 201, the deep learning accelerator 203, the artificial neural network 301, any component of the system 100, any combination thereof, or by utilizing any other appropriate program, network, system, or device. At step 814, the method 800 may include applying an inverse Fast Fourier Transform to the matrix-vector product for each pixel in each image to convert each image patch back to the spatial domain from the frequency domain. In certain embodiments, the application of the inverse Fast Fourier Transform may be performed and/or facilitated by utilizing the first user device 102, the second user device 111, the server 140, the server 145, the server 150, the server 160, the communications network 135, the integrated circuit device 201, the deep learning accelerator 203, the artificial neural network 301, any component of the system 100, any combination thereof, or by utilizing any other appropriate program, network, system, or device.

At step 816, the method 800 may include facilitating reconstruction of the convolved version of the input image corresponding to the original input image. In certain embodiments, the reconstructions may be conducted by discarding overlapping regions of the image patches. In certain embodiments, the reconstructing of the convolved version of the input image may be performed and/or facilitated by utilizing the first user device 102, the second user device 111, the server 140, the server 145, the server 150, the server 160, the communications network 135, the integrated circuit device 201, the deep learning accelerator 203, the artificial neural network 301, any component of the system 100, any combination thereof, or by utilizing any other appropriate program, network, system, or device. At step 818, the method 800 may include copying the retained portions of the image patches next to each other to generate the reconstructed convolved image. For example, the reconstructed image may be reconstructed by combining the retained portions of the image patches (not including the discarded overlapping regions) to form the reconstructed image corresponding to the original input image. In certain embodiments, the copying of the retained portions of the image patches and combined the patches together may be performed and/or facilitated by utilizing the first user device 102, the second user device 111, the server 140, the server 145, the server 150, the server 160, the communications network 135, the integrated circuit device 201, the deep learning accelerator 203, the artificial neural network 301, any component of the system 100, any combination thereof, or by utilizing any other appropriate program, network, system, or device.

At step 820, the method 800 may include outputting the reconstructed convolved image corresponding to the original input image. In certain embodiments, the outputting of the reconstructed image may be performed and/or facilitated by utilizing the first user device 102, the second user device 111, the server 140, the server 145, the server 150, the server 160, the communications network 135, the integrated circuit device 201, the deep learning accelerator 203, the artificial neural network 301, any component of the system 100, any combination thereof, or by utilizing any other appropriate program, network, system, or device. At step 822, the method 800 may include performing the artificial intelligence task using the reconstructed image corresponding to the original input image. For example, of the artificial intelligence task is a computer vision task, the system 100 may utilize the image to perform image classification, image segmentation, object detection, content-based image retrieval, other tasks, or a combination thereof. In certain embodiments, the performing of the artificial intelligence tasks may be performed and/or facilitated by utilizing the first user device 102, the second user device 111, the server 140, the server 145, the server 150, the server 160, the communications network 135, the integrated circuit device 201, the deep learning accelerator 203, the artificial neural network 301, any component of the system 100, any combination thereof, or by utilizing any other appropriate program, network, system, or device. In certain embodiments, the method 800 may be repeated as desired and/or by the system 100. Notably, the method 800 may incorporate any of the other functionality as described herein and may be adapted to support the functionality of the system 100.

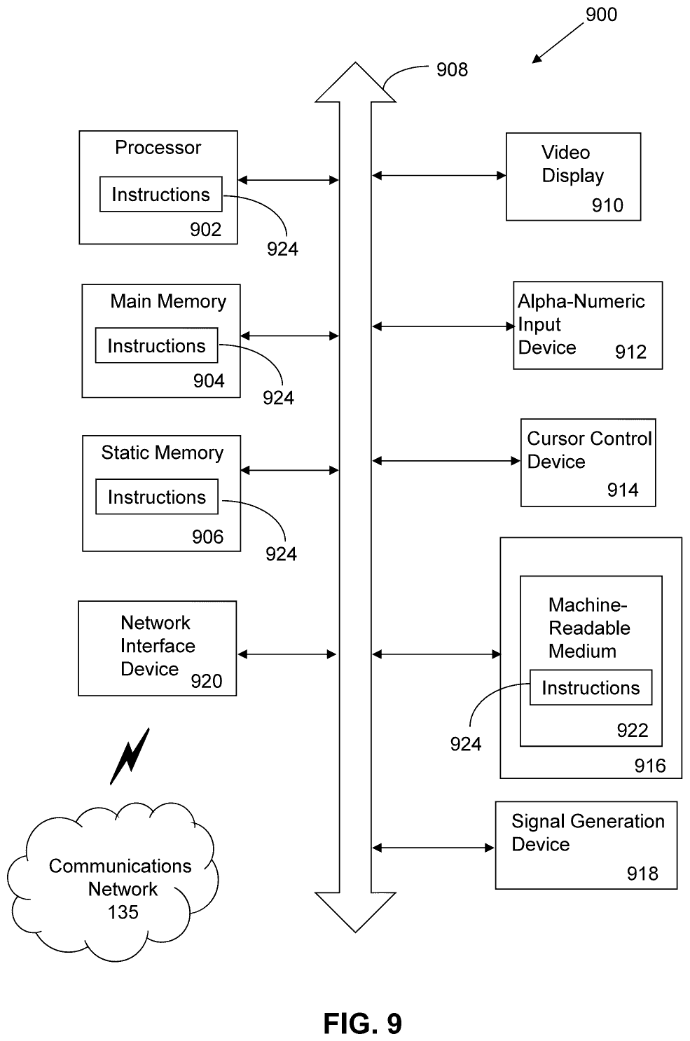

Referring now also to FIG. 9, at least a portion of the methodologies and techniques described with respect to the exemplary embodiments of the system 100 and/or methods 700, 800 can incorporate a machine, such as, but not limited to, computer system 900, or other computing device within which a set of instructions, when executed, may cause the machine to perform any one or more of the methodologies or functions discussed above. The machine may be configured to facilitate various operations conducted by the system 100. For example, the machine may be configured to, but is not limited to, assist the system 100 by providing processing power to assist with processing loads experienced in the system 100, by providing storage capacity for storing instructions or data traversing the system 100, or by assisting with any other operations conducted by or within the system 100. As another example, in certain embodiments, the computer system 900 may assist in receiving input images for artificial intelligence tasks, dividing images into image patches, applying Fast Fourier Transforms to the image patches, padding image filters with zeroes to adjust the size of the image filter to a size of the image patches, applying Fast Fourier Transforms to the padded image filter, computing matrix-vector products between channels of each image patch and a matrix from a corresponding pixel location in the padded image filter, applying inverse Fast Fourier Transforms to the matrix-vector products for each pixel in each image patch to convert each image patch to a spatial domain from a frequency domain, reconstructing a convolved version of the input image by discarding overlapping regions of the image patches or by summing overlapping edges of the image patches together, outputting the reconstructed image, performing artificial intelligence tasks using the reconstructed image, and/or performing any other operations of the system 100.

In some embodiments, the machine may operate as a standalone device. In some embodiments, the machine may be connected (e.g., using communications network 135, another network, or a combination thereof) to and assist with operations performed by other machines and systems, such as, but not limited to, the first user device 102, the second user device 111, the server 140, the server 145, the server 150, the database 155, the server 160, any other system, program, and/or device, or any combination thereof. The machine may be connected with any component in the system 100. In a networked deployment, the machine may operate in the capacity of a server or a client user machine in a server-client user network environment, or as a peer machine in a peer-to-peer (or distributed) network environment. The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The computer system 900 may include a processor 902 (e.g., a central processing unit (CPU), a graphics processing unit (GPU, or both), a main memory 904 and a static memory 906, which communicate with each other via a bus 908. The computer system 900 may further include a video display unit 910, which may be, but is not limited to, a liquid crystal display (LCD), a flat panel, a solid-state display, or a cathode ray tube (CRT). The computer system 900 may include an input device 912, such as, but not limited to, a keyboard, a cursor control device 914, such as, but not limited to, a mouse, a disk drive unit 916, a signal generation device 918, such as, but not limited to, a speaker or remote control, and a network interface device 920.

The disk drive unit 916 may include a machine-readable medium 922 on which is stored one or more sets of instructions 924, such as, but not limited to, software embodying any one or more of the methodologies or functions described herein, including those methods illustrated above. The instructions 924 may also reside, completely or at least partially, within the main memory 904, the static memory 906, or within the processor 902, or a combination thereof, during execution thereof by the computer system 900. The main memory 904 and the processor 902 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine-readable medium 922 containing instructions 924 so that a device connected to the communications network 135, another network, or a combination thereof, can send or receive voice, video or data, and communicate over the communications network 135, another network, or a combination thereof, using the instructions. The instructions 924 may further be transmitted or received over the communications network 135, another network, or a combination thereof, via the network interface device 920.

While the machine-readable medium 922 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that causes the machine to perform any one or more of the methodologies of the present disclosure.

The terms “machine-readable medium,” “machine-readable device,” or “computer-readable device” shall accordingly be taken to include, but not be limited to: memory devices, solid-state memories such as a memory card or other package that houses one or more read-only (non-volatile) memories, random access memories, or other re-writable (volatile) memories; magneto-optical or optical medium such as a disk or tape; or other self-contained information archive or set of archives is considered a distribution medium equivalent to a tangible storage medium. The “machine-readable medium,” “machine-readable device,” or “computer-readable device” may be non-transitory, and, in certain embodiments, may not include a wave or signal per se. Accordingly, the disclosure is considered to include any one or more of a machine-readable medium or a distribution medium, as listed herein and including art-recognized equivalents and successor media, in which the software implementations herein are stored.

The illustrations of arrangements described herein are intended to provide a general understanding of the structure of various embodiments, and they are not intended to serve as a complete description of all the elements and features of apparatus and systems that might make use of the structures described herein. Other arrangements may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Thus, although specific arrangements have been illustrated and described herein, it should be appreciated that any arrangement calculated to achieve the same purpose may be substituted for the specific arrangement shown. This disclosure is intended to cover any and all adaptations or variations of various embodiments and arrangements of the invention.

Combinations of the above arrangements, and other arrangements not specifically described herein, will be apparent to those of skill in the art upon reviewing the above description. Therefore, it is intended that the disclosure is not limited to the particular arrangement(s) disclosed as the best mode contemplated for carrying out this invention, but that the invention will include all embodiments and arrangements falling within the scope of the appended claims.

The foregoing is provided for purposes of illustrating, explaining, and describing embodiments of this invention. Modifications and adaptations to these embodiments will be apparent to those skilled in the art and may be made without departing from the scope or spirit of this invention. Upon reviewing the aforementioned embodiments, it would be evident to an artisan with ordinary skill in the art that said embodiments can be modified, reduced, or enhanced without departing from the scope and spirit of the claims described below.

What is claimed is:

1. A system, comprising:
a memory; and
a deep learning accelerator configured to execute instructions from the memory, wherein the deep learning accelerator is configured to;
divide an input image associated with an artificial intelligence task into equally-sized partially overlapping image patches;
apply, by utilizing a neural network, a Fast Fourier Transform to each of the equally-sized partially overlapping image patches;
compute, for each pixel in each image patch of the equally-size partially overlapping image patches, a matrix-vector product between at least one channel of each image patch and a matrix from a corresponding pixel location in an image filter;
apply an inverse Fast Fourier Transform to the matrix-vector product for each pixel in each image patch to convert each image patch to a spatial domain; and
reconstruct, after application of the inverse Fast Fourier Transform, a convolved version of the input image by summing overlapping portions of each image patch together.

2. The system of claim 1, wherein the deep learning accelerator is further configured to pad the image filter with zeroes until an image filter size of the image filter is adjusted to correspond to the size of each of the equally-sized partially overlapping image patches.

3. The system of claim 2, wherein the deep learning accelerator is further configured to apply the Fast Fourier Transform to the image filter prior to computation of the matrix-vector product.

4. The system of claim 1, wherein the deep learning accelerator is further configured to output the convolved version of the input image.

5. The system of claim 4, wherein the deep learning accelerator is further configured to perform the artificial intelligence task using the convolved version of the input image that is outputted.

6. The system of claim 1, wherein the equally-sized partially overlapping image patches correspond to a frequency domain after application of the Fast Fourier Transform to each of the equally-sized partially overlapping image patches.

7. The system of claim 1, wherein the input image received by utilizing the neural network corresponds to the spatial domain.

8. The system of claim 1, wherein the deep learning accelerator is further configured to determine a size of the overlapping portions based on an image filter size of the image filter.

9. The system of claim 1, wherein the deep learning accelerator is further configured to generate mappings between first channels of the input image onto second channels of the convolved version of the input image.

10. The system of claim 1, wherein the deep learning accelerator is further configured to cache frequency domain versions of the equally-sized partially overlapping image patches after application of the Fast Fourier Transform to the equally-sized partially overlapping image patches.

11. The system of claim 10, wherein the deep learning accelerator is further configured to reuse the cached frequency domain versions of the equally-sized partially overlapping image patches in a convolutional layer.

12. A device, comprising:
a deep learning accelerator configured to:
apply a Fast Fourier Transform to each equally-sized partially overlapping image patches of an input image;
apply the Fast Fourier Transform to an image filter after adjustment of an image filter size;
compute, for each pixel in each image patch of the equally-size partially overlapping image patches, a matrix-vector product between at least one channel of each image patch and a matrix from a corresponding pixel location in the image filter;
apply an inverse Fast Fourier Transform to the matrix-vector product for each pixel in each image patch to convert each image patch to a spatial domain; and
reconstruct, after application of the inverse Fast Fourier Transform, a convolved version of the input image by discarding overlapping regions of the image patches.

13. The device of claim 12, wherein the deep learning accelerator is further configured to facilitate reconstruction of the convolved version of the input image by copying retained portions of the image patches.

14. The device of claim 13, wherein the deep learning accelerator is further configured to facilitate reconstructions of the convolved version of the input image by combining the retained portions of the image patches with each other to generate the reconstructed convolved image.

15. The device of claim 14, wherein the deep learning accelerator is further configured to output the reconstructed convolved image.

16. The device of claim 12, wherein the deep learning accelerator is further configured to adjust the image filter size by padding the image filter with zeroes until the image filter size corresponds to the size of each of the equally-sized partially overlapping image patches.

17. The device of claim 12, wherein the deep learning accelerator is further configured to receive, by utilizing a neural network, the input image for use for an artificial intelligence task.

18. A method, comprising:
splitting an input image into partially overlapping image patches;
applying, by utilizing a deep learning accelerator, a Fast Fourier Transform to each of the partially overlapping image patches and to an image filter;
computing, for each pixel in each image patch of partially overlapping image patches, a matrix-vector product between at least one channel of each image patch and a matrix from a corresponding pixel location in the image filter;
applying an inverse Fast Fourier Transform to the matrix-vector product for each pixel in each image patch to convert each image patch to a spatial domain; and
reconstructing, after application of the inverse Fast Fourier Transform, a convolved version of the input image.

19. The method of claim 18, further comprising applying a Fast Fourier Transform to the image filter to convert the filter to a frequency domain.

20. The method of claim 18, further comprising reconstructing the convolved version of the input image by discarding overlapping regions of the image patches and combining retained portions of the image patches, or by summing the overlapping regions of the image patches together.
